(19) United States
(12) Patent Application Publication
(10) Pub. No.: US 2009/0015402 A1
(43) Pub. Date: Jan. 15, 2009

(54) System Method and Device for Providing Asynchronous Event Driven Reminders

(76) Inventor: Eli Reifman, Ra'anana (IL)

Correspondence Address: Davidson, Davidson & Kappel, LLC, 485 7th Avenue, 14th Floor, New York, NY, 10018, US

(21) Appl. No.: 11/778,051

(22) Filed: Jul. 15, 2007

(51) Int. Cl. G08B 21/00

(52) U.S. Cl. 340/540

(57) ABSTRACT

The present invention is a device method and system for providing asynchronous event based reminders in the context of a mobile communication/computing device. According to some embodiments of the present invention, integral with a communication/computing device there may be provided a Reminder Logic Module functionally associated with or integral with an Event Register, an Event Receiving Unit, an Event Correlation Unit and an Event Action/Response Triggering Unit.

### FIELD OF THE INVENTION

The present invention relates to the field of computing. More specifically, the present invention relates to a system method and device for providing asynchronous event driven reminders.

### BACKGROUND

In recent decades, electronic technology, including communication technology, has revolutionized our everyday lives. Electronic devices such as Personal Digital Assistants (“PDA's”), cell phones, mobile media players and digital cameras have permeated the lives of almost every person living in the developed world—and quite a number of people living in undeveloped countries. Mobile communication and computing devices, especially, have become the means by which countless millions conduct their personal and professional interactions with the world. It has become almost impossible for many people, especially those in the business world, who use these devices as a means to improve productivity, to function without access to their electronic devices. Today's mobile communication devices (e.g. smart cellular phones) go far beyond their original purpose of voice communication. They now support text messaging, Internet access, entertainment packages, photography, shared calendars and reminders, and much more. The probability for even greater functionality is high, driven by three related forces: consumer demand, market competition and mobile infrastructure improvements.

One of the present day features mobile communication devices provide is time based reminders for various aspects of their personal and professional life, such as a reminder to be ready for the upcoming meeting or to watch your favorite TV show in 15 minutes. Many mobile devices are now network with office calendar/scheduling systems, and users are able to received reminders of and update calendar entries remotely. Users may share or publish their calendars remotely. However, all calendar entries and associated reminders are time based and have no connection to the environment or location in which the user finds them selves.

There is a need in the field of mobile communication/computing for a devices method and system to provide reminders based on asynchronous events such as location, received calls, made calls, and numerous other asynchronous factors.

### SUMMARY OF THE INVENTION

The present invention is a device method and system for providing asynchronous event based reminders in the context of a mobile communication/computing device. According to some embodiments of the present invention, integral with a communication/computing device there may be provided a Reminder Logic Module functionally associated with or integral with an Event Register, an Event Receiving Unit, an Event Correlation Unit and an Event Action/Response Triggering Unit.

The Event Receiving Unit may receive one or more synchronous and asynchronous event indicators from one or a set of communication/computing-device components or subsystems functionally associated with the Reminder Logic Module. The Event Receiving Unit may receive an event indicator about and from anyone of the following: (1) Time—Clock Circuitry, (2) Location—Location Derivation Block (GPS based location derivation or Network Base-Station ID Based location derivation), (3) Communication Session (Inbound and Outbound) Information—device controller which coordinates communication circuitry of the communication/computing device, and (4) User Initiated Input—user input devices such as (a) keypad, (b) microphone, (c) camera, and (d) biometric reader.

According to some embodiments of the present invention, received event indicators may be correlated by an Event Correlation Unit with event records stored in the Event Register to determine whether the received event requires an Action or Response according to any of the stored event records. An event record may consist of data such as: (1) event type, (2) conditions, (3) pointers to PIM data, and (4) event response/actions to be triggered by the event. Event records may store absolute event data (Triggers, Conditions and Action/Responses), for example, upon receiving a call from a specific phone number or upon the device being at specific coordinates (longitude and latitude), between the hours of 8 am and 3 pm, pop up reminder to call a specific number. Event records may store relative or meta-data (Triggers, Conditions and Action/Responses), for example, upon receiving a call from John Smith (phone number stored in Personal Information Management database) or upon the device being in Paris (correlate GPS output or local base station ID with database), between the hours of 8 am and 3 pm, pop up reminder to call Mother and dial Mother's number (phone number stored in Personal Information Management database). An Event Action/Response Triggering Unit may signal the device controller to implement Actions/Responses associated with a received event correlated with an event record in the Event Register.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing the functional blocks of an exemplary mobile device including a reminder logic module in accordance with some embodiments of the present invention;

FIG. 2 is a block diagram of an exemplary reminder logic module in accordance with some embodiments of the present invention;

FIG. 3A is a data structure diagram showing an exemplary event register in accordance with some embodiments of the present invention;

FIG. 3B is a data structure diagram showing sample data within an exemplary event register in accordance with some embodiments of the present invention;

FIGS. 4A to 4C are exemplary flowcharts including the steps of various methods by which a reminder logic module in accordance with some embodiments of the present invention may function.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a device method and system for providing asynchronous event based reminders in the context of a mobile communication/computing device. According to some embodiments of the present invention, integral with a communication/computing device there may be provided a Reminder Logic Module functionally associated with or integral with an Event Register, an Event Receiving Unit, an Event Correlation Unit and an Event Action/Response Triggering Unit.

The Event Receiving Unit may receive one or more synchronous and asynchronous event indicators from one or a set of communication/computing device components or subsystems functionally associated with the Reminder Logic Module. The Event Receiving Unit may receive an event indicator about and from anyone of the following: (1) Time—Clock Circuitry, (2) Location—Location Derivation Block (GPS based location derivation or Network Base-Station ID Based location derivation), (3) Communication Session (Inbound and Outbound) Information—device controller which coordinates communication circuitry of the communication/computing device, and (4) User Initiated Input—user input devices such as (a) keypad, (b) microphone, (c) camera, and (d) biometric reader.

According to some embodiments of the present invention, received event indicators may be correlated by an Event Correlation Unit with event records stored in the Event Register to determine whether the received event requires an Action or Response according to any of the stored event records. An event record may consist of data such as: (1) event type, (2) conditions, (3) pointers to PIM data, and (4) event response/actions to be triggered by the event. Event records may store absolute event data (Triggers, Conditions and Action/Responses), for example, upon receiving a call from a specific phone number or upon the device being at specific coordinates (longitude and latitude), between the hours of 8 am and 3 pm, pop up reminder to call a specific number. Event records may store relative or meta-data (Triggers, Conditions and Action/Responses), for example, upon receiving a call from John Smith (phone number stored Personal Information Management database) or upon the device being in Paris (correlate GPS output or local base station ID with database), between the hours of 8 am and 3 pm, pop up reminder to call Mother and dial Mother's number (phone number stored Personal Information Management database). An Event Action/Response Triggering Unit may signal the device controller to implement Actions/Responses associated with a received event correlated with an event record in the Event Register.

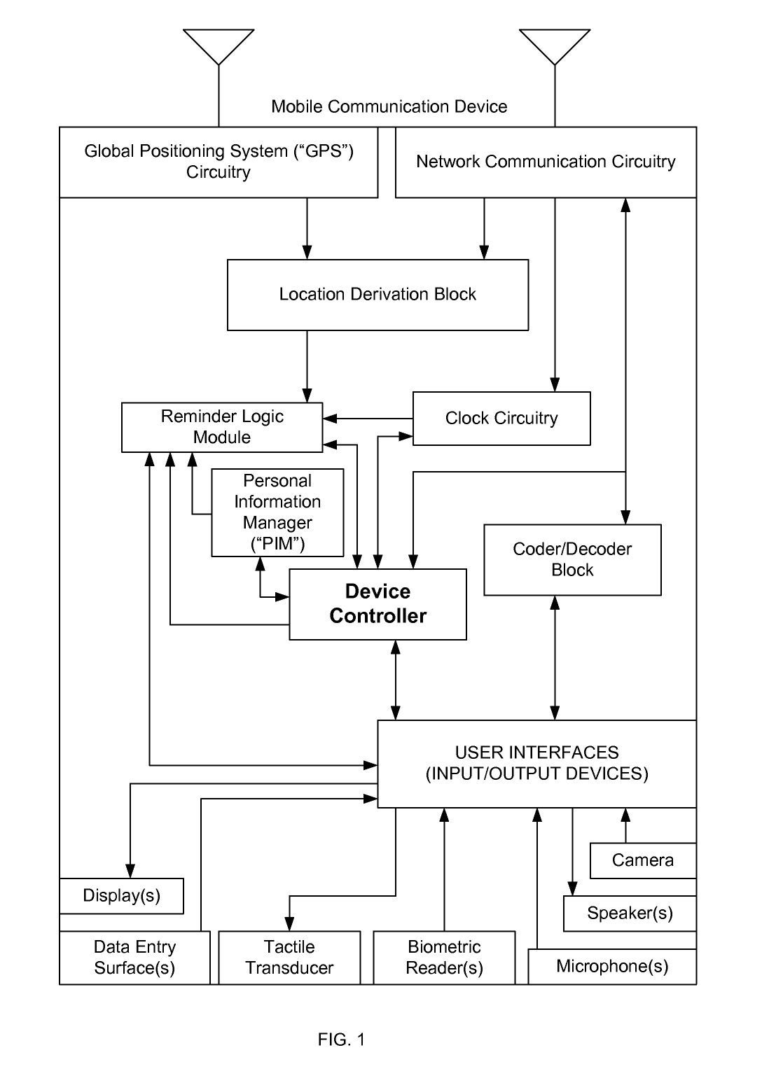

Turning now to FIG. 1, there is shown a block diagram showing the functional blocks of an exemplary mobile device including a reminder logic module in accordance with some embodiments of the present invention. The reminder logic module may receive one or more synchronous and asynchronous event indicators from one or a set of communication/computing device components or subsystems functionally associated with the Reminder Logic Module. The event indicators may be received directly from the components which generate the indicator or through a controller.

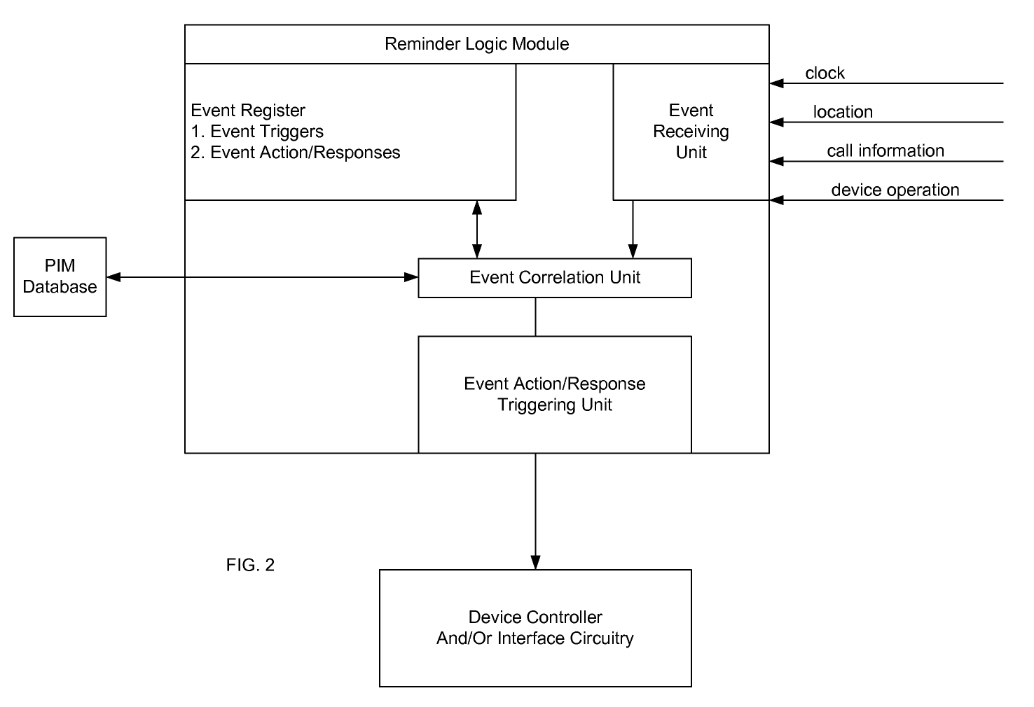

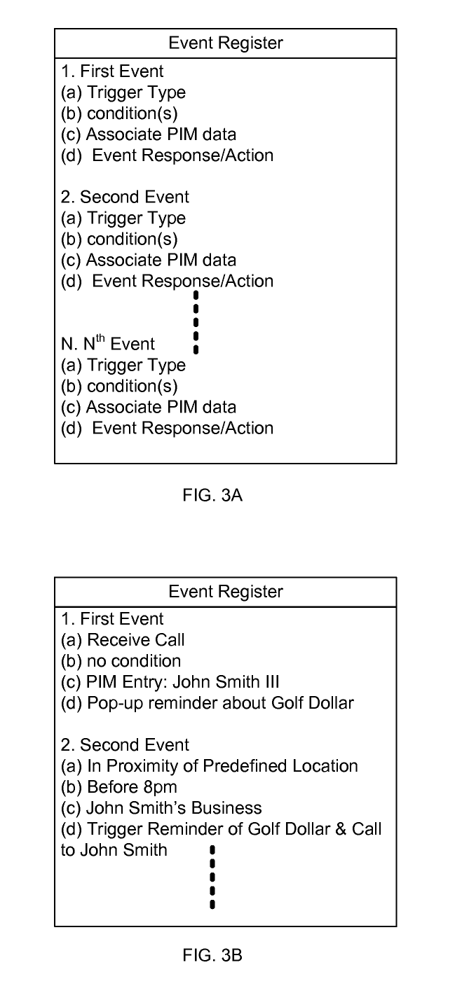

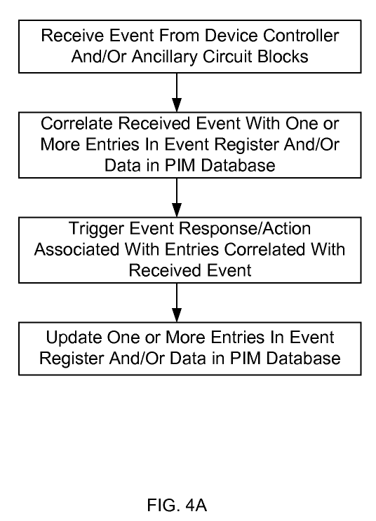

Turning now to FIG. 2, there is shown a block diagram of an exemplary reminder logic module in accordance with some embodiments of the present invention. The reminder logic module may include an event receiving unit adapted to receive event indicators, an event register adapted to store events (FIG. 3A is a data structure diagram showing an exemplary event register in accordance with some embodiments of the present invention, and FIG. 3B shows a data structure diagram showing sample data within an exemplary event register in accordance with some embodiments of the present invention), and an event correlation unit adapted to correlate received event indicators with events stored in the register. The event correlation unit may also use data stored in a PIM database or other associated database(s) (e.g. global positioning or base-station ID databases) in determining correlations between received event indicators and entries in the event register. An event action/response triggering unit may signal a device controller to initiate actions/responses associated with event entries correlating to received event indicators.

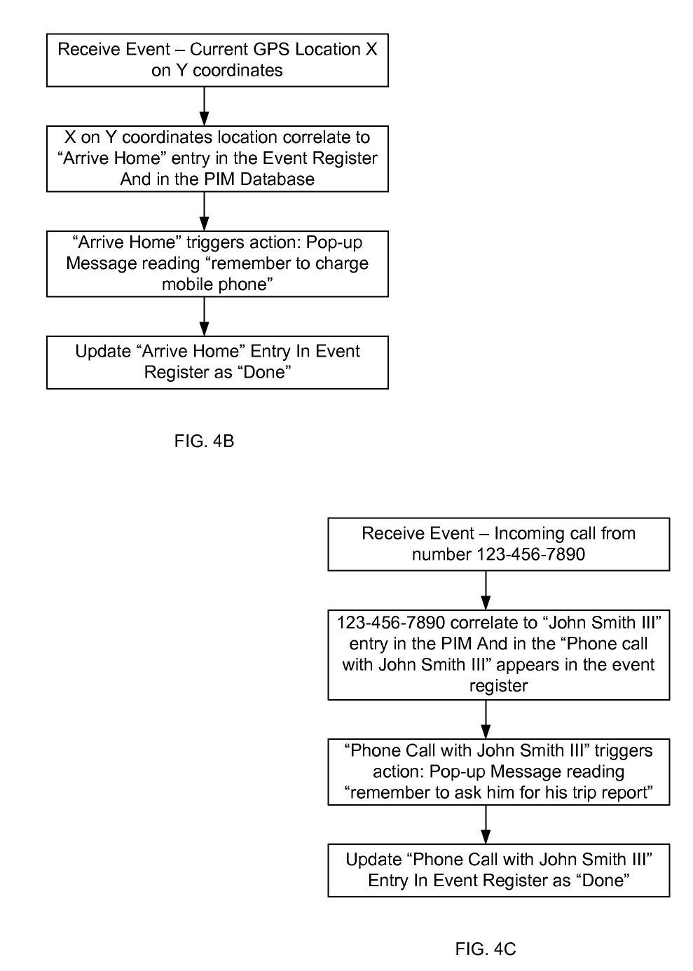

Turning now to FIGS. 4A to 4C, there are shown exemplary flowcharts including the steps of various exemplary methods by which a reminder logic module in accordance with some embodiments of the present invention may function based on different event register entries. FIG. 4A is a general flowchart, whereas FIGS. 4B and 4C give specific examples.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A communication device comprising:
a mobile communication device controller; and
a reminder logic module adapted to correlate a detected asynchronous event with an entry in an event register.

2. The communication device according to claim 1, further comprising an event response/action unit adapted to trigger a device function associated with a register entry correlated to the detected asynchronous event.

3. The communication device according to claim 1, wherein the detected asynchronous event is associated with an event type selected from the groups of event types consisting of device location, received communication, transmitted communication, biometric reading, predefined user input, predefined intentionally acquired data, and predefined background acquired data.

4. The communication device according to claim 1, wherein said reminder logic is also adapted to correlates time with the entry in the event register.

5. A method of triggering reminders through a mobile device, said method comprising:
detecting one or more asynchronous events through a mobile device circuit; and
correlating the one or more detected asynchronous events with an entry in an event register functionally associated with the mobile device.

6. The method according to claim 5, further comprising an event triggering a device function associated with a register entry correlated to the detected asynchronous event.

7. The method according to claim 5, wherein the detected asynchronous event is associated with an event type selected from the groups of event types consisting of device location, received communication, transmitted communication, biometric reading, predefined user input, predefined intentionally acquired data, and predefined background acquired data.

8. The method device according to claim 5, wherein time is also correlated with the entry in the event register.

9. A reminder logic module comprising
an Event Receiving Unit adapted to receive asynchronous events a component or subsystem of a device with which said logic module is functionally associated.

10. The module according to claim 9, further comprising a correlation unit adapted to correlate a received asynchronous event with an entry in an event register.

11. The module according to claim 10, further comprising an event response/action unit adapted to trigger a device function associated with a register entry correlated to the detected asynchronous event.

12. The module according to claim 10, wherein the detected asynchronous event is associated with an event type selected from the groups of event types consisting of device location, received communication, transmitted communication, biometric reading, predefined user input, predefined intentionally acquired data, and predefined background acquired data.
